(19) United States
(12) Patent Application Publication
(10) Pub. No.: US 2026/0084369 A1
(43) Pub. Date: Mar. 26, 2026

(54) DOUBLE-SIDED, HIGH-RELIEF EMBOSSMENTS ON THERMOPLASTIC SHEETS

(71) Applicant: 3Form, LLC, Salt Lake City, UT (US)

(72) Inventors: Cameron L. Reynolds, Salt Lake City, UT (US); Dax K. Pettibone, American Fork, UT (US); Ryan G. Smith, Seattle, WA (US); Anthony V. Villegas, Salt Lake City, UT (US)

(21) Appl. No.: 19/338,787

(22) Filed: Sep. 24, 2025

Related U.S. Application Data
(60) Provisional application No. 63/698,460, filed on Sep. 24, 2024.

(51) Int. Cl. B29C 59/02; B29K 101/12; B29K 105/00; B32B 3/30; B32B 27/08

(52) U.S. Cl. CPC B29C 59/026; B32B 3/30; B32B 27/08; B29K 2101/12; B29K 2105/256; B29K 2995/002; B29K 2995/0026; B29K 2995/0029; B32B 2307/402; B32B 2307/412; B32B 2307/414; B32B 2307/7376

(57) ABSTRACT

An architectural thermoplastic panel includes double-sided, high-relief embossments formed simultaneously during a controlled heating and pressure process. A first major surface of the panel includes a first high-relief embossment and a second major surface opposite the first major surface includes a second high-relief embossment. The embossments may exhibit cohesive structural interactions through the thickness of the panel, producing complementary or registered features that improve rigidity, distribute stresses, and alter acoustic response. Each embossment can have a depth and substantially similar fidelity and surface finish. The embossments can also redirect light through the panel body, causing visual effects such as prismatic separation, refraction, diffusion, scattering, or gradient banding. In some embodiments, the panel is transparent or translucent, permitting viewing of registered patterns from either side.

### CROSS-REFERENCE TO RELATED APPLICATIONS

This application claims the benefit of and priority to U.S. Provisional Application No. 63/698,460, entitled DOUBLE-SIDED, HIGH-RELIEF EMBOSSMENTS ON THERMOPLASTIC SHEETS, filed on Sep. 24, 2024, the entirety of which is incorporated herein by reference.

### BACKGROUND

### 1. Technical Field

The present disclosure generally relates to architectural panels featuring high-relief embossments and methods of manufacturing such panels.

### 2. Background and Relevant Art

Architectural panels may be prefabricated building components commonly used as a versatile solution to enhance both the aesthetic appeal and functional performance of a space or structure. Manufacturers of architectural panels may craft these panels from a variety of material types, including but not limited to fabrics, metals, alloys, woods, concrete, glass, and composites, each offering benefits to both aesthetic and functional performance.

Architects and designers may use textured architecture panels to add depth, visual interest, and character to a surface. Textures may create patterns, shadows, and reflections that change with light and other surrounding conditions, adding a dynamic element to the facade of their surfaces. Manufacturers may manipulate texture to influence how a viewer interprets scale, materiality, color, and form while enhancing functional aspects such as grip, fluid runoff, or acoustic performance. Thus, textured panels may add further aesthetic and functional purpose to architectural panels.

Manufacturers may apply texture to architectural panels using a variety of techniques, each tailored to the specific material and desired effect. Cutting methods, such as laser cutting or water jetting, may create precise patterns and intricate designs.

Mechanical pressing may use molds or embossing tools to imprint textures onto metal, wood, or composite surfaces. Manufacturers may also employ a layering technique which involves adding multiple coatings or layers of materials, like fabrics or thin veneers, to create depth and contrast. Other methods, like sandblasting or etching, selectively remove surface material to produce raised or recessed textures, enhancing both visual and tactile qualities of the panels.

Methods that employ high-relief embossments are difficult to manage, generally requiring expensive molds and surface finishes. This is sometimes done by using a CNC (Computer Numerical Control) machine to cut out an inexpensive material, such as wood, to provide the right types of features. Wood, however, insulates heat and can make passing of the texture at the precisely desired height/width specifications difficult or impossible. Moreover, the wood can break in the press after a few uses. Metal-based molds may be more reliable, but they are too heavy and tend to be too expensive to both apply intricate embossments as well as to use in an environment where a wide range of patterns are desired.

Accordingly, there are a number of problems in the art that can be addressed.

### BRIEF SUMMARY

Implementations of the present disclosure provide architectural thermoplastic sheets with double-sided high-relief embossments and a method to manufacture architectural thermoplastic sheets with double-sided high-relief embossments in a cost-effective, flexible, and reliable manner. In particular, implementations of the present invention are configured to provide high-fidelity, high-relief embossments onto both sides of a thermoplastic sheet through the use of opposing molds and the application of heat and pressure.

In particular, at least one embodiment, an architectural panel can include a first major surface having a first high-relief embossment depressed into it, and a second major surface opposite the first major surface, the second major surface having a second high-relief embossment depressed into it. The first high-relief embossment and the second high-relief embossment can each have a surface topology defined by one or more depressed regions. Additionally, the one or more depressed regions of the first high-relief embossment can exhibit cohesive structural interactions with the one or more depressed regions of the second high-relief embossment through a thickness of the architectural panel.

In another embodiment, an architectural panel can include a first major surface having a first high-relief embossment depressed into it, and a second major surface opposite the first major surface, the second major surface having a second high-relief embossment depressed into it. The first high-relief embossment and the second high-relief embossment can be formed simultaneously during a heating process. Additionally, the first high-relief embossment and the second high-relief embossment can exhibit substantially similar fidelity, depth, and surface finish. Further, the first high-relief embossment and the second high-relief embossment can each have a depth of at least 0.125 inches.

In a further embodiment, an architectural panel can include a first major surface having a first high-relief embossment depressed into it, and a second major surface opposite the first major surface, the second major surface having a second high-relief embossment depressed into it. The first high-relief embossment and the second high-relief embossment can include a surface topology defined by one or more depressed regions. Additionally, the one or more depressed regions of the first high-relief embossment can exhibit cohesive structural interactions with the one or more depressed regions of the second high-relief embossment through a thickness of the architectural panel. Further, the first high-relief embossment and the second high-relief embossment can cause a light that passes through the architectural panel to exhibit a visual effect. Still further, the one or more depressed regions of the first high-relief embossment and the second high-relief embossment each have a depth of at least 0.125 inches.

In a still further embodiment, a method for manufacturing an architectural panel with high-relief embossments on a first major surface and a second major surface can include forming a sealed layup assembly. The sealed layup assembly can include a first mold, a second mold, one or more release films, a thermoplastic sheet, and a flexible vacuum container. The method can also include coupling the sealed layup assembly to a vessel through one or more tubes configured to allow for a transfer of air between the sealed layup assembly and the vessel. The method may additionally include inserting and sealing the sealed layup assembly inside the vessel, where the vessel has a temperature and a pressure. The method may further include subjecting the sealed layup assembly to a molding process at a predetermined temperature, a predetermined pressure, and a predetermined duration. The predetermined temperature can cause an internal temperature of the thermoplastic sheet to meet or exceed 210 degrees Fahrenheit. The first high-relief embossment is formed on the first major surface and a second high-relief embossment is formed on the second major surface simultaneously.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a process of layering molds, release film, and thermoplastic sheets of the present disclosure;

FIG. 1B illustrates a process of sealing the layers of FIG. 1A in a vacuum compartment;

FIG. 1C illustrates a process of inserting the sealed layers of FIG. 1B into a heated pressure vessel;

FIG. 1D illustrates the release of the sealed layers of FIG. 1B;

FIG. 2A illustrates an architectural panel of the present disclosure;

FIG. 2B illustrates a top perspective view of the architectural panel of FIG. 2A;

FIG. 2C illustrates a bottom perspective view of the architectural panel of FIG. 2A;

FIG. 2D illustrates a side cross-sectional view of the architectural panel of FIG. 2A;

FIG. 3A illustrates a front perspective view of a mold of the present disclosure;

FIG. 3B illustrates a front perspective view of another embodiment of a mold of the present disclosure;

FIG. 3C illustrates front perspective view of yet another embodiment of a mold of the present disclosure;

FIG. 4 illustrates a layup assembly of the present disclosure;

FIG. 5 illustrates a sealed layup assembly of the present disclosure;

FIG. 6A illustrates an example architectural panel of the present disclosure;

FIG. 6B illustrates a line drawing cross-sectional view of the architectural panel of FIG. 6A;

FIG. 7A illustrates a front, facing view of an architectural panel of the present disclosure;

FIG. 7B illustrates a back, perspective view of the architectural panel in FIG. 7A;

FIG. 7C illustrates a front, facing view of an architectural panel of the present disclosure;

FIG. 7D illustrates a cross-sectional side view of the panel shown in FIG. 7C;

FIG. 8 illustrates light interaction through an architectural panel of the present disclosure; and

FIG. 9 illustrates a method 900 for manufacturing an architectural panel with high-relief embossments on a first major surface and a second major surface.

### DETAILED DESCRIPTION

The present disclosure generally relates to architectural thermoplastic sheets with double-sided high-relief embossments and a method to manufacture architectural thermoplastic sheets with double-sided high-relief embossments in a cost-effective, flexible, and reliable manner. In particular, implementations of the present invention are configured to provide high-fidelity, high-relief embossments onto both sides of a thermoplastic sheet through the use of opposing molds and the application of heat and pressure. In particular, embodiments of the present invention illustrate the existence of high-relief embossments on the opposing sides of a single or layered set of thermoplastic sheets.

A manufacturer can form a panel of the present disclosure by using a sealed layup assembly that is subjected to heat and pressure inside a vessel. The processes and methods disclosed herein can enable simultaneous embossment on both sides of the thermoplastic sheet. The embossments can be high-relief embossments. As used in this disclosure, a “high-relief embossment” means a raised and/or recessed/depressed surface feature that extends into or away from the base plane or surface of a panel or sheet. A manufacturer can alter the mold configuration (e.g., dimensions and material type) as well as the panel material thickness and composition to vary or control the depth of a panel's surface features. These surface features can range in depth from approximately 0.005 inches to approximately 0.75 inches or more than 0.75 inches. High-relief embossments can feature geometric or non-geometric patterns as well as produce visual, tactile, or structural effects. Since the processes and methods of the present disclosure simultaneously form high-relief embossments on both sides of a panel, the high-relief embossments on either side of a panel can have the same or substantially similar fidelity, depth, and surface finish.

As mentioned above, the panels of the present disclosure can serve structural, aesthetic, or combined purposes. A manufacturer can select embossment depth to manipulate light transmission, refraction, and shadowing across the panel surface. Due to the deeper embossments achievable through the present disclosure, the panels can scatter or diffuse light by directing the light through the panels'various thicknesses or by bouncing or passing the light through various curves or geometries. A manufacturer uses high-relief embossments, which can create visual complexity and privacy effects. The panel's thickness and overall transparency can further affect these effects.

As used herein, the term “visual effect” refers to any observable alteration in transmitted, reflected, or emergent light resulting from interaction with the surface topology of the panel. Non-limiting examples of visual effects include changes in color, brightness, opacity, direction, or diffusion of light. Such effects can arise from the cohesive structural interactions or registration orientations of opposing embossments that redirect light through the thickness of the panel, producing phenomena such as prismatic separation, refraction, scattering, gradient banding, or shimmer. In some embodiments, the structural interactions between the opposing high-relief embossments can generate complex light behaviors that resemble destructive and non-destructive wave pattern interactions. As light passes through the depressions, interference effects (e.g., lighting or visual effects) may occur, such as producing alternating regions of intensified brightness and reduced illumination. These interactions can enhance prismatic separation, introduce shifting bands of color, or create dynamic shimmer effects that change with viewing angle or incident light direction.

The embossment depth and panel thickness can also influence how a panel interacts with sound. For example, deeper surface features can scatter sound waves, reducing sharp reflections and softening acoustic response within a space. A manufacturer can vary panel thickness to adjust how much sound passes through or reflects off the panel by altering the embossment's depth and overall pattern.

The high-relief embossments of the present disclosure can contribute to the structural performance of a panel. A manufacturer can utilize deeper surface features to enhance rigidity across the panel, thereby reducing flex under load or thermal expansion. For example, a given pattern with alternating protruding regions and recessed/depressed regions can stiffen a large-format panel without increasing material thickness. The high-relief embossments can also redirect stress across the surface, allowing the panel to distribute mechanical loads more evenly. A manufacturer can tune these structural effects, and various other structural effects, by adjusting embossment depth, spacing, and orientation relative to the panel's intended mounting or use condition.

Now turning to the Figures, the Figures illustrate various features and elements of the disclosed acoustic panels. The Figures show examples and embodiments of architectural panel configurations, mold arrangements, and the processes and methods that can be used to form high-relief embossments on both major surfaces of a thermoplastic sheet.

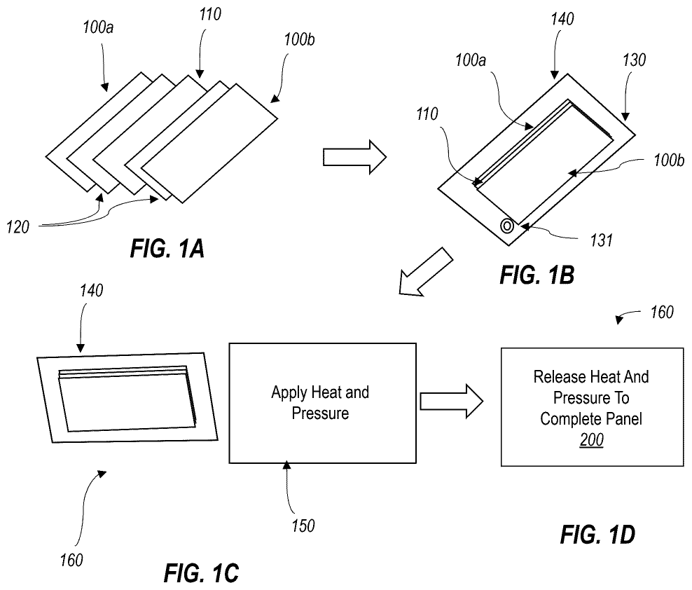

FIGS. 1A, 1B, 1C, and 1D schematically illustrate a process of using pressure and heat to form a thermoplastic sheet 110 into an architectural panel with high-relief embossments on both major surfaces. FIG. 1A shows that a first substrate or high-relief mold 100a can be placed into contact with a release film 120. A manufacturer can include one or more release films 120 such that a first release film is in contact with the mold 100a and a second release film is then placed into contact with the first release film. Release film 120 can serve multiple purposes beyond facilitating separation from the mold. In some embodiments, a manufacturer can select a release film 120 that imparts a glossy finish to the thermoplastic sheet 110. In another embodiment, a release film 120 can carry micro-scale texture, allowing the panel to exhibit fine surface detail in addition to the high-relief embossments. A manufacturer can vary the type, thickness, or surface treatment of the release film to achieve specific visual or tactile effects. Similarly, a manufacturer may layer two or more release films 120 to achieve a plurality of effects or outcomes (i.e., surface finish and tactile effects). In some cases, a manufacturer may omit the release film entirely, relying on mold surface properties or alternative releasing agents. The decision to include or exclude release films can depend on the desired finish, mold material, and post-processing requirements.

FIG. 1A also shows that following the mold 100a and release film 120, a thermoplastic sheet 110 can be included. As used herein, the term “thermoplastic sheet” refers to a panel formed from any one of the following thermoplastic polymers (or alloys or combinations thereof). Specifically, such materials can include but are not limited to, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high-density polyethylene, polypropylene), thermoplastic polyurethane (TPU), cellulose-based polymers (cellulose acetate, cellulose butyrate or cellulose propionate), poly lactic acid (PLA), or the like. The thermoplastic sheet 110 can have the same or similar dimensions to the mold 100a and the release film 120 such that each of the edges of the thermoplastic sheet aligns with each of the edges of the mold 100a and the release film 120. In at least one embodiment, the thermoplastic sheet, the release film 120, and the mold 100a have varied dimensions such that one or more of the layers'edges do not align with the remaining layers.

FIG. 1A shows that the manufacturer can then lay or stack a second (or additional) layer of release films 120. Similar to the first (or plurality of first) release films 120, a manufacturer may utilize one or more release films 120 on the opposite side of the thermoplastic sheet 110, such that both major surfaces of the thermoplastic sheet abut or are in contact with one or more release film 120 layers. The number of release film 120 layers on the first major surface may vary from the number of release film 120 layers on the second major surface.

FIG. 1A also illustrates that a second substrate or high-relief mold 100b can then be layered or stacked to correspond with the second major surface. In some embodiments, the high-relief molds 100a and 100b can be substantially similar in form and construction. For example, the pattern that mold 100a imparts or depresses into a panel can be the same or similar to the pattern that mold 100b imparts. In another embodiment, the molds 100a and 100b can be complementary in nature, such that mold 100a imparts a pattern or texture onto the thermoplastic sheet 110 while mold 100b imparts a registered or rotated pattern or texture on the opposing side of the thermoplastic sheet 110. For example, the pattern imparted by mold 100a may be the same as the pattern imparted by mold 100b; however, the orientation of the pattern of mold 100a can be rotated 90 degrees relative to the pattern of mold 100b. This registered and/or rotated configuration can produce visual effects that shift depending on viewing angle or light direction. A manufacturer can use this approach to create panels with dynamic surface behavior, layered visual depth, or directional texture. Furthermore, rotated or offset patterns can reduce the occurrence of pattern repetition or moiré effects due to the high-relief embossments existing on both sides of an architectural panel. In yet another embodiment, the high-relief molds 100a and 100b can be distinct from each other and in the embossments that each imparts onto the thermoplastic sheet 110, such that the high-relief embossment on the first major surface of the architectural panel comprises a first texture or pattern and the second major surface of the architectural panel comprises a second and distinct texture or pattern.

The manufacturer can utilize various methods to ensure the alignment and positioning of each layer described above. Such methods include and are not limited to, manual manipulation of the layers, optical alignment systems, mechanical alignment pins and holes, laser alignment markers, camera-based vision systems, alignment jigs and fixtures, contact alignment pads, vacuum-assisted alignment platforms, magnetic alignment devices, edge-guided alignment rails, ultrasonic alignment sensors, X-ray alignment systems, alignment templates or masks, computer numerical control (CNC) alignment, digital pattern recognition software, alignment calibration grids, adjustable clamping mechanisms, interference fit grooves and slots, and any other such method or system.

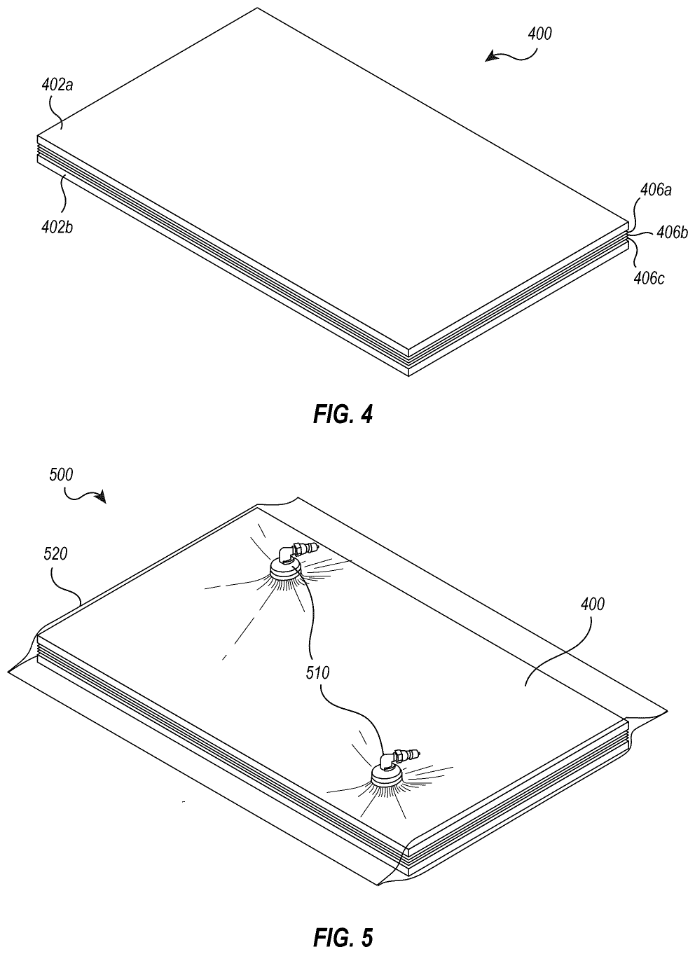

FIG. 1B illustrates how, after layering or stacking mold 100a, release film(s) 120, thermoplastic sheet 110, another release film(s) 120, and mold 100b, a manufacturer can insert these layers into a flexible vacuum container 130, creating a sealed layup assembly 140. Vacuum container 130 can be a bag, pouch, set of sealed sheets or films, envelope, wrapping, or any other sealable and flexible container. Vacuum container 130 can compress or contract around the above-discussed layers such that the molds, release films, and thermoplastic sheet maintain close contact and alignment throughout the heating process (see also FIG. 4). This compression can reduce air pockets, limit slippage between layers, and ensure uniform pressure distribution across the panel surface. A manufacturer can use a vacuum container 130 to preserve or promote the fidelity of the high-relief embossments imparted and maintain a consistent texture and finish on both major surfaces of the thermoplastic sheet 110. The vacuum container 130 can comprise materials such as, but not limited to, polyethylene (PE), polypropylene (PP), nylon, mylar (metalized polyester), laminated films, polyvinyl chloride (PVC), rubber, silicone, foil, TPU (thermoplastic polyurethane), and the like.

In some embodiments, vacuum container 130 comprises one or more valves 131 that pass through a side or surface of the vacuum container 130. For example, in another embodiment, vacuum container 130 comprises two or more valves 131 (see FIG. 4). Valve 131 can be used to evacuate air from sealed layup assembly 140. In another embodiment, a manufacturer can utilize valve 131 to connect a pressure gauge to vacuum container 130, thereby monitoring the pressure during the formation of high-relief embossments.

FIG. 1C illustrates a single sealed layup assembly 140 receiving an application of heat and pressure inside a vessel 150. However, a manufacturer can select one or more sealed layup assemblies 140 that they then position inside the vessel 150. The one or more sealed layup assemblies 140, in combination with the vessel 150, can be referred to as a panel creation system 160. Within the panel creation system, a manufacturer can couple a sealed layup assembly 140 to the vessel 150 through one or more hoses or tubing that allows the vessel 150 to control the pressure of the vacuum container. Additionally, the manufacturer may couple the vessel 150 to a sealed layup assembly 140 with one or more temperature or pressure probes, such that the vessel 150 or the manufacturer can monitor the pressure and temperature of the sealed layup assembly.

The manufacturer can cause the vessel's 150 temperature and pressure (and/or the temperature and pressure of the sealed layup assembly) to be increased through a controlled ramp-up, where the temperature and pressure are incrementally increased from an initial set point to a specified holding set point. The initial set points can be ambient conditions. In another embodiment, the manufacturer can preliminarily heat or pressurize the sealed layup assembly 140. Pressures during the heating process can range from about 10 PSI to about 200 PSI, such as from about 20 PSI to about 180 PSI, including about 50 PSI to about 150 PSI, or about 60 PSI to about 120 PSI, or about 80 PSI to about 100 PSI. Temperatures during the heating process can range from about 80° F. to about 400° F., such as from about 100° F. to about 350° F., including about 150° F. to about 300° F., or about 180° F. to about 280° F., or about 200° F. to about 250° F. The pressures and temperatures applied during the heating process through vessel 150 can be selected as any individual value or sub-range within the above-listed ranges.

The manufacturer can also cause the vessel's temperature and pressure (and/or the temperature and pressure of the sealed layup assembly) to be decreased by a controlled ramp-down, wherein the temperature and pressure are incrementally decreased from the holding set point to a desired final set point or ambient conditions. The controlled release or ramp-down can ensure the sealed layup assembly does not shift, which may cause damage to the fidelity, finish, and structure of the imparted or depressed high-relief embossments. In at least one embodiment, the vessel or manufacturer can cause multiple ramp-ups and ramp-downs to occur in varied orders. Additionally, the duration of the forming process (the application of heat and pressure) can occur for a set duration. Thus, each ramp-up and ramp-down cycle may also have a set duration. For example, a forming process (i.e., from the introduction of any heat or temperature to the sealed layup assembly and any cool-down time) can take anywhere from 80 minutes to 450 minutes. For instance, the forming process may take about 100 minutes to 400 minutes, 150 minutes to 350 minutes, or 200 minutes to 300 minutes, depending on the desired outcome. In at least one embodiment, the manufacturer can subject the sealed layup assembly to a sustained temperature and pressure for a selected duration or for the forming process.

FIG. 1D illustrates panel creation system 160, wherein the manufacturer can secure or seal vessel 150 (e.g., a lamination press or autoclave) to apply heat and pressure. In some embodiments, vessel 150 can be an autoclave, such as a steam autoclave, chemical autoclave, pressure cooker autoclave, lab autoclave, or composite autoclave, wherein the manufacturer can have complete control over at least the internal pressure and temperature of the vessel. In another embodiment, the vessel can be a press such as a hydraulic press, mechanical press, pneumatic press, screw press, heat press, roller press, or blanking press. The manufacturer can adjust and modify the pressure and temperature to which the thermoplastic sheet 110 is exposed, based on various conditions within the panel creation system 160. At least the thickness, material type, and desired texture finish of thermoplastic sheet 110 can control the manufacturer's decision-making process. An autoclave vessel or similar device wherein the pressure is exerted onto the sealed layup assembly without a physical, mechanical press can be advantageous, as it can provide precise control over its temperature and pressure, and it may allow for less slip or movement between the layers within the sealed layup assembly 140.

The process illustrated in FIG. 1A-1D shows that a first high-relief embossment is formed on a first major surface of a thermoplastic sheet at the same time that a second high-relief embossment is formed on a second major surface of the thermoplastic sheet. The simultaneous formation of the embossments can advantageously prevent the degradation of the first high-relief embossment if the second were to be formed after it in a separate process

A first exemplary example of the process described in FIG. 1A-1D includes positioning a thermoplastic polyurethane (TPU) sheet between opposing mold surfaces within a sealed layup assembly. The manufacturer places the assembly into a pressure vessel and initiates a vacuum environment. The manufacturer heats the vessel to a temperature ranging from approximately 200° F. to 280° F. and applies pressure ranging from approximately 80 to 100 PSI. The manufacturer maintains these conditions for a duration between approximately 20 and 100 minutes, allowing the TPU sheet to conform to the mold surfaces. The manufacturer then reduces the temperature to below approximately 100° F. and gradually releases the pressure.

A second exemplary example includes arranging a thermoplastic sheet formed from an organic polymer between two textured molds within a sealed layup assembly. The manufacturer evacuates the assembly and inserts it into a pressure vessel. The manufacturer heats the vessel to a temperature ranging from approximately 220° F. to 280° F. and applies an initial pressure ranging from approximately 1 to 15 PSI. The manufacturer maintains these conditions for a duration of approximately 50 to 100 minutes, allowing the sheet to soften and conform to the mold surfaces. The manufacturer then increases the pressure to a range of approximately 100 to 180 PSI and maintains it for an additional duration between approximately 20 and 180 minutes. The manufacturer reduces the temperature to below approximately 100° F. and gradually releases the pressure.

A third exemplary example involves placing a polycarbonate sheet between opposing molds within a sealed layup assembly. The operator inserts the assembly into a pressure vessel and heats it to a temperature ranging from approximately 300° F. to 370° F. The operator applies pressure ranging from approximately 80 to 150 PSI and maintains these conditions for a duration between approximately 50 and 90 minutes. After the molding phase, the operator reduces the temperature to below approximately 100° F. and gradually releases the pressure. The resulting architectural panel includes each of the above example results in high-relief embossments on both major surfaces, each with a depth of at least 0.125 inches and exhibiting substantially similar surface finish and fidelity

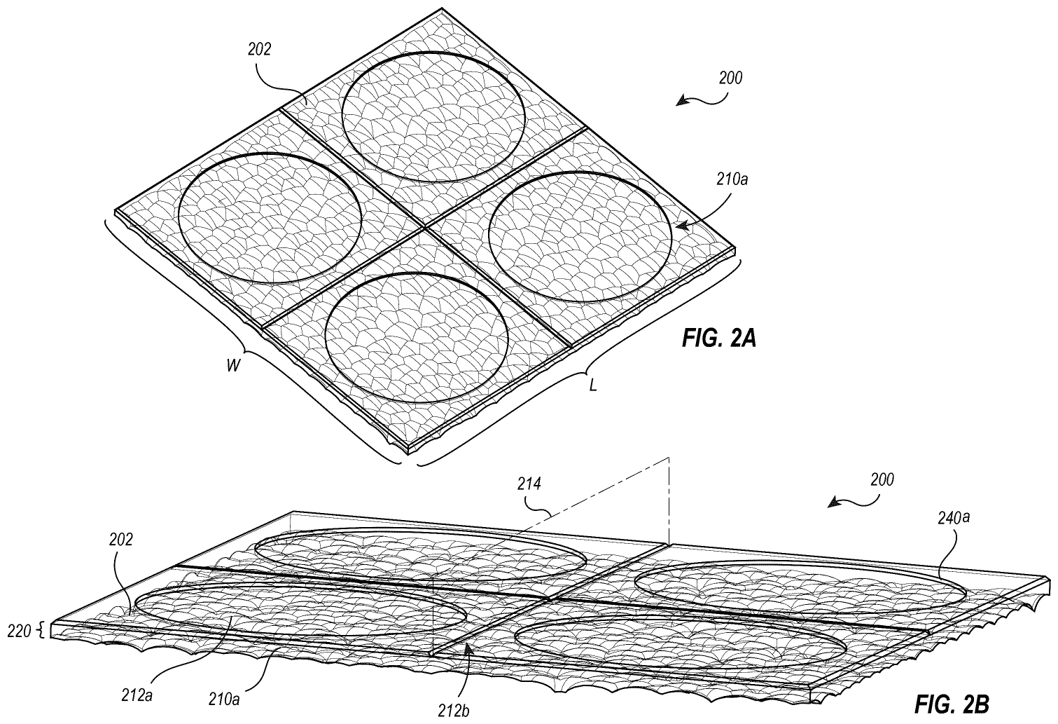

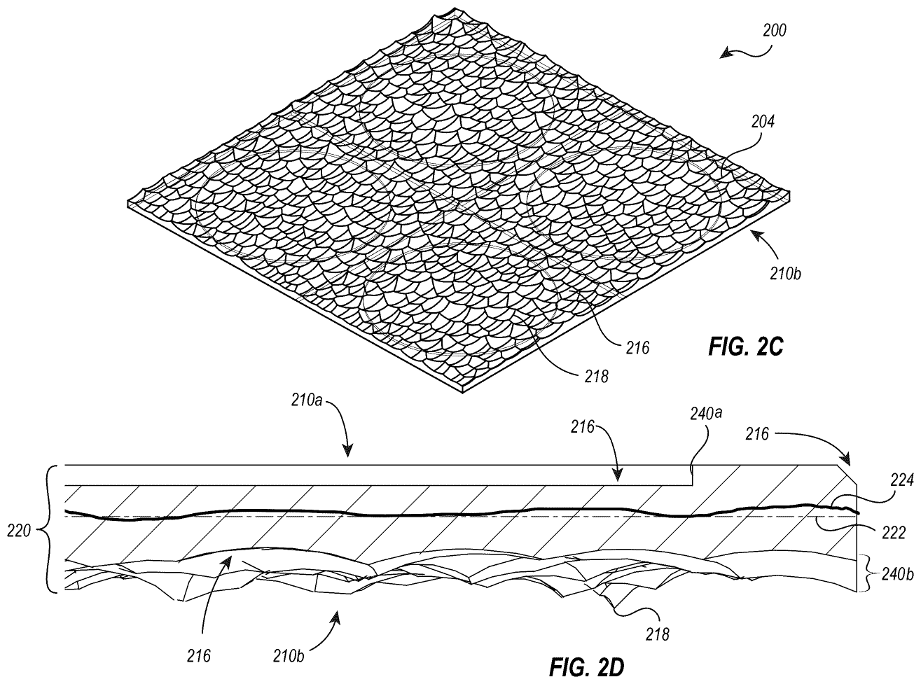

FIGS. 2A, 2B, 2C, and 2D illustrate an exemplary embodiment of an architectural panel 200 that exhibits double-sided, high-relief embossments. FIG. 2A is a front view of an architectural panel 200. A manufacturer can form the architectural panel 200 from any one of the following thermoplastic polymers (or combinations thereof). Specifically, such materials can include but are not limited to, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high-density polyethylene, polypropylene), thermoplastic polyurethane (TPU), cellulose-based polymers (cellulose acetate, cellulose butyrate or cellulose propionate), poly lactic acid (PLA), or the like.

FIG. 2A shows that panel 200 includes a first major surface 202 featuring a pattern 210a, which comprises various high-relief embossments 212a. First major surface 202 is a surface of the panel that has its surface area defined by the length (L) and width (W) of the panel 200. In some embodiments, architectural panel 200 is substantially opaque, preventing the transmission of light through and providing enhanced privacy or protection against light exposure. In other embodiments, architectural panel 200 can be non-opaque, such as semi-transparent or substantially transparent, allowing partial or complete transmission of light. The manufacturer can select a desired level of opacity based on the specific requirements or preferences for the intended application of architectural panel 200. Transparent panels can reveal imperfections in the finish, fidelity, or registration of a given high-relief embossment, as the depth and detail can be more apparent than in a much lower-relief embossment or texture. In such cases, even minor inconsistencies in embossment depth, surface smoothness, or alignment between opposing textures can detract from the visual clarity and perceived quality of the panel. However, the process and methods disclosed herein can provide a pathway to a transparent panel with high-fidelity, high-relief embossments.

FIG. 2B is a side view of the architectural thermoplastic panel 200, illustrating the depth 240a of the high-relief embossment 212a. The processes and methods of the present disclosure can cause molds to form a recessed region having a depth 240a into a thermoplastic panel. Depth 240a can range from about 0.005 inches to about 0.5 inches. For example, depth 240a can range from about 0.05 inches to about 0.4 inches, or from about 0.08 inches to about 0.3 inches, or from about 0.1 inches to about 0.25 inches, or from about 0.15 inches to about 0.2 inches. The depth 240a may be characterized by a dimensional range selected from any of the intervals mentioned above, or alternatively, may comprise a discrete value residing within any portion of said ranges. High-relief embossment 212a is a substantially circular indentation or embossment. As shown, a majority, if not all, of the area of the circular indentation or embossment (high-relief embossment 212a) has a uniform or uninterrupted depth. In at least one embodiment, a portion of the circular indentation or embossment (high-relief embossment 212a) can have varying or non-uniform depth.

FIG. 2B also shows high-relief embossment 212b, which is depicted as a linear channel. As shown, high-relief embossment 212b is a continuous linear recessed region of the surface, having a continuous depth along its length 214 or for a distance across the first major surface. In an alternative or additional embodiment, high-relief embossment 212b can be a non-linear channel, such as a wave, spiral, or circle.

FIG. 2B also shows that architectural panel 200 has a thickness 220. A manufacturer can define a thickness 220 depending on the structure and aesthetic function of the architectural panel 200. Thickness 220 can range in values, such as from approximately or at least 0.125 inches to approximately or at least 1 inch, 2 inches, 3 inches, or more. For example, thickness 220 can have a value 0.125 inches, about 0.15 inches, about 0.20 inches, about 0.25 inches, about 0.30 inches, about 0.35 inches, about 0.40 inches, about 0.45 inches, about 0.50 inches, about 0.55 inches, about 0.60 inches, about 0.65 inches, about 0.70 inches, about 0.75 inches, about 0.80 inches, about 0.85 inches, about 0.90 inches, about 0.95 inches, about 1.00 inch. The thickness 220 manufacturer can advantageously select thickness 220 so that the imparting of high-relief embossment 212a does not diminish the overall structural integrity of architectural thermoplastic panel 200. Further, the thickness 220 can define the maximum depth 240a that is achievable for a given panel.

FIG. 2C is a rear view of the architectural panel 200, which illustrates the second major surface 204 featuring the second pattern 210b. As illustrated, pattern 210b can differ from the visual pattern/geometry of pattern 210a. In another embodiment, patterns 210a and 210b are substantially similar in their structure or geometry. In some embodiments, a manufacturer can register patterns 210a and 210b relative to one another to impart a particular visual or pattern when viewed together through the transparent or semi-transparent panel. For example, an orientation of pattern 210a (or a given high-relief embossment within pattern 210a) is registered at an angle of about 90 degrees relative to an orientation of the second pattern 210b. Pattern 210b can be geometric or nongeometric in nature, as well as aperiodic or periodic. As illustrated, pattern 210b is non-geometric, having various recessed regions 216 and protruding regions 218 which form a plurality of divots across the second major surface 204. Each recessed region 216 can have the same or a similar depth (see FIG. 2D for depth 240a and 240b), or they can vary in depth. In this example, depth 240a (see FIG. 2D) can be defined as the distance the recessed region 216 travels from its starting position (e.g., the height or position of the first major surface of the panel before any treatment) or as a height difference between at least one of the one or more recessed regions and an unmolded remainder of the first major surface. Depth can also be defined by the distance in elevation between the recessed region 216 and the protruding region 218 (assuming the height of the protruding region 218 has not moved from its starting position/before any treatment).

FIG. 2D is a side perspective view of the architectural panel 200, illustrating the depth 240b of the pattern 210b and the depth 240a of the pattern 210a. Each of the one or more recessed regions can have variable depth, meaning portions of the recessed regions are either deeper or shallower than other portions of their recessed regions. As illustrated, recessed regions 216 are divots wherein the outer areas of the recessed regions are shallower than the areas towards their center. Thus, depth 240 can be a measure of the deepest part of the recessed region 216. Patterns 210a and 210b exhibit cohesive structural interactions with each other, as indicated by the centerline 222 relative to the thermoplastic layer 224. These structural interactions can be a byproduct of the simultaneous formation of patterns 210a and 210b.

As used herein, the term “cohesive structural interactions” refers to the physical continuity of material through the thickness of the panel, such that the formation of one or more recessed or protruding regions on a first major surface of the panel causes a corresponding displacement, redistribution, or deformation of material that extends toward the second major surface. In some embodiments, cohesive structural interactions can include complementary or registered embossments that share a common deformation line or interaction line within the panel body. In other embodiments, cohesive structural interactions can be defined by the manner in which opposing embossments redirect material and stresses through the thickness of the panel to produce a coupled structural relationship between the first major surface and the second major surface. Accordingly, cohesive structural interactions distinguish panels of the present disclosure from panels where surface textures are applied independently to opposing surfaces without material continuity through the panel body.

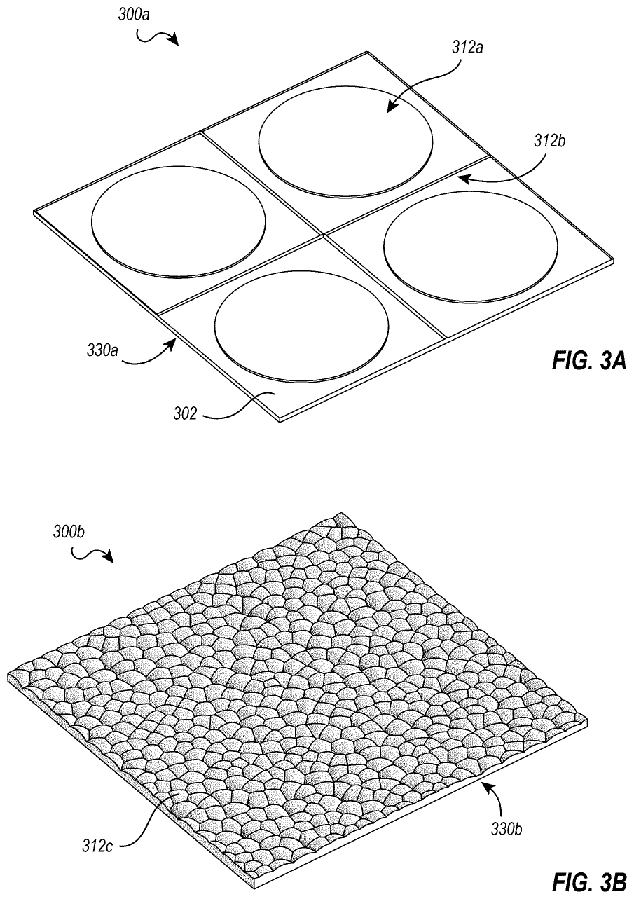

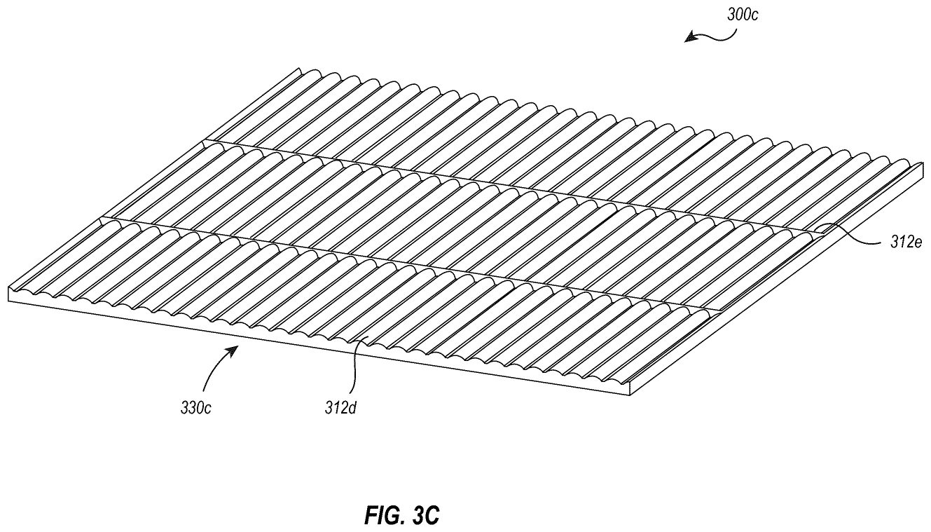

FIG. 3A illustrates an exemplary embodiment of a first substrate or mold 300a. A manufacturer can form mold 300a from at least any one of the following materials: metal, plastic, silicone, rubber, ceramic, glass, graphite, composite, wood, aluminum, stainless steel, bronze, cast iron, carbon fiber, or the like. A manufacturer's selection of material can be based on a variety of conditions, not limited to the depth of the mold part 312a and 312b, the desired finish of the final architectural panel, the heat transfer coefficient of the material, compressibility of the material, elasticity of the material, resilience of the material, creep of the material, etc. For example, a manufacturer may use a silicon mold because it can have more usable working cycles than a mold made from a less resilient material. Mold 300a comprises a surface featuring mold parts 312a and 312b (e.g., together known as a pattern). Mold parts 312a and 312b can be the same or a similar material to that of the mold 300a itself. In at least one embodiment, the surface texture of mold parts 312a and 312b may be matted or smooth, which enables the mold part to create a smooth embossment into a thermoplastic panel. Similarly, the surface texture of the major surface 302 of mold 300a can control whether the remainder of the thermoplastic panel has a textured or smoothed surface.

In some embodiments, high-relief mold 300a may only have one variation of a mold part. In another embodiment, high-relief mold 300a can have two or more high-relief patterns disposed onto one of its major surfaces. As illustrated in FIG. 3B, mold parts 312a and 312b have a substantially similar height (allowing them to impart the same depth of embossment into a thermoplastic sheet); however, they vary in geometric shape. For example, mold part 312a has a general form of a protruding circle (e.g., protruding away from the major surface 302) that would impart a circular indentation into a thermoplastic sheet. Mold part 312b, however, is a linear structure of material that would impart a channel into a thermoplastic sheet. In alternative or additional embodiments, mold parts can have substantially different or complementary characteristics, such as depth and shape. Together, mold parts 312a and 312b form a pattern, which is a periodic pattern consisting of perpendicular lines that bound circles. Mold parts of the present disclosure can impart various geometric shapes or non-geometric shapes into a thermoplastic sheet. For example, geometric shapes can include but are not limited to circles, squares, triangles, rectangles, hexagons, octagons, diamonds, parallelograms, trapezoids, polygons, spirals, chevrons, grids, stripes, tessellations, stars, waves, zigzags, ellipses, and fractals. Non-geometric shapes can include but are not limited to waves, ripples, organic contours, stippling, meanders, irregular textures, naturalistic forms, abstract patterns, and other freeform embossments.

FIG. 3A illustrates that high-relief mold 300a has a thickness 330a that can range from 0.25 inches to 1.5 inches thick or even thicker. This thickness may include the height of mold parts 312a and 312b. Alternatively, each mold part of the present disclosure may have a height that directly correlates with the desired depth of a high-relief embossment. Thickness 330a can affect the embossments created through its use. For example, a thicker mold may have more structural rigidity and be able to withstand more use or more extreme use (higher temperatures and pressures). The molds of the present disclosure can have a lifetime of about 20 to about 100 heating/processing cycles. For example, the molds may have a lifetime of 30 to 90 cycles, or 40 to 80 cycles, or 50 to 70 cycles. Thickness, material type/quality, and process variable (temperature, pressure, and duration) can affect the useful cycles of a mold.

FIG. 3B illustrates another embodiment of a second substrate or 300b having a thickness 330b. Mold 300b can have substantially the same characteristics as mold 300a (e.g., material, dimensions, etc.). As illustrated in FIG. 3B, mold 300b exhibits a non-geometric pattern, such as an abstract, organic, freeform, or cellular pattern. Mold parts 312c define a pattern, which includes variously shaped and sized bulbs that mesh together in an organic nature. Thus, due to their non-geometric and organic shaping, mold parts 312b can have a variety of depths. Molds 300b and 300a can be considered a set or pair of molds such that when registered with one another, they create a complete pattern, desired visual, or desired light effect. FIGS. 2A-2D illustrate the combination of molds 300a and 300b.

FIG. 3C illustrates another embodiment of a mold 300c having a thickness 330c. Mold 300c can have substantially the same characteristics as molds 300a or 300b (dimensions, material type, etc.). As illustrated, mold 300c comprises a geometric design with various vertical and horizontal lines and protruding cylinders. Mold 300c comprises a pattern defined by mold parts 312d and 312e. The pattern formed by mold parts 312d and 312e is periodic or repeating. Molds 300c and 300a, 300c and 300b, or even two 300c molds can be considered a set or pair of molds, such that when registered with one another, a manufacturer can create a complete pattern, visual, or light effect. A manufacturer can manipulate or orient these molds to create combined visual/light effects. For example, a set of linear grooves on one mold may be paired with a different registration or orientation of the same set of linear grooves, of a corresponding mold, to create a combined aesthetic that appears to be squares, a circle with squares, overlapping lines, or waves with overlapping lines, and so forth when a viewer views the transparent or semi-transparent architectural panel.

FIG. 4 illustrates layup assembly 400, consisting of molds 402a and 402b. Each mold is positioned on opposing sides of thermoplastic sheets 406a, 406b, and 406c. Thermoplastic sheets 406a and 406c are semi-transparent sheets, and thermoplastic sheet 406b can be a thermoplastic sheet having a desired color. In at least one embodiment, thermoplastic sheet 406b may be replaced with an alternative or additional layer (thermoplastic or non-thermoplastic) that has a desired color, pattern, tint, or other features. In at least one embodiment, one or more release films can be layered between the mold and the thermoplastic sheets. Thus, layup assembly can include 2, 3, 4, 5, 6, or more release film layers. For example, a manufacturer may avoid the use of release films completely or may include a release film on only one side of the thermoplastic sheet. In another embodiment, a manufacturer can include a releasing agent other than a release film. A manufacturer can utilize a flexible vacuum container (see FIG. 5) to seal and ensure the alignment of the various layers of layup assembly 400.

FIG. 5 illustrates the layup assembly 400 of FIG. 4, inside a flexible vacuum bag or container 520, forming a sealed layup assembly 500. Flexible vacuum containers, such as flexible vacuum container 520, can be formed from materials including polyethylene (PE), polypropylene (PP), nylon, Mylar (metalized polyester), laminated films, polyvinyl chloride (PVC), rubber, silicone, foil, TPU (thermoplastic polyurethane), and the like. In some embodiments, flexible vacuum container 520 can be a bag, pouch, set of sealed sheets or films, wrapping, envelope, or any other sealable flexible container. FIG. 5 shows that valves 510 pass through or are secured to the flexible vacuum container 520. Valves 510 allow the sealing of layup assembly 400 to form a sealed layup assembly 500. A manufacturer can apply negative pressure to sealed layup assembly 500 by vacuuming the air out of the sealed layup assembly 500 through valves 510. The manufacturer can also use valve 510 to connect pressure gauges or temperature sensors. When the negative pressure or vacuum is applied to the sealed layup assembly 500 before it is connected or inserted into a vessel for the application of temperature and pressure, this process is referred to as a cold vacuum treatment. A cold vacuum can include evacuating air and/or warming the now sealed layup assembly 500 to advantageously ensure the introduction of heat and pressure achieves the intended results, such as proper registration and alignment. In some embodiments, the duration of a cold vacuum process can range from 0.25 hours to 10 hours.

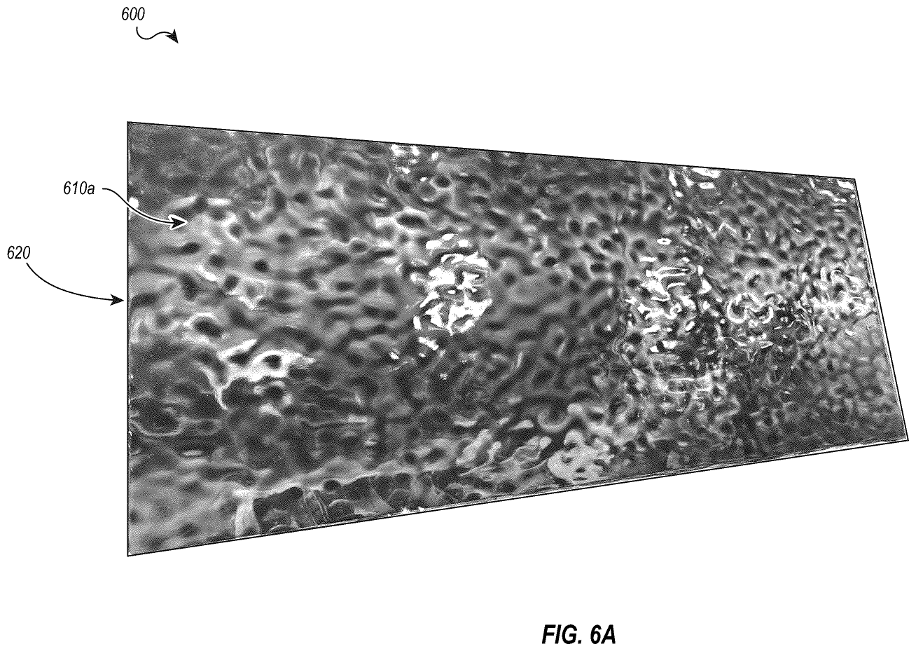

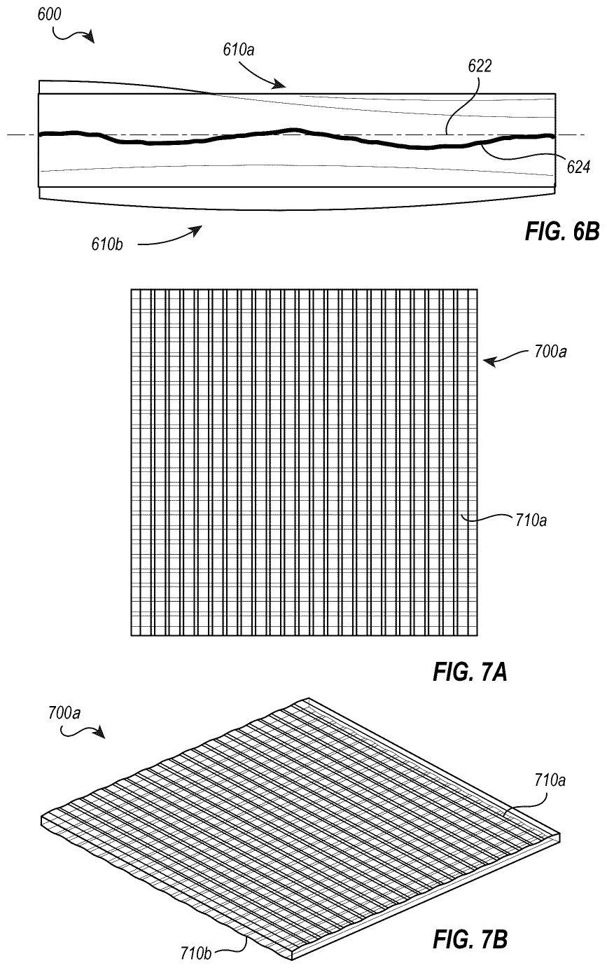

FIG. 6A illustrates an exemplary embodiment of architectural panel 600 (or thermoplastic sheet) mounted in frame 620. Pattern 610a is illustrated, consisting of an undulating fluid-like pattern. As shown, architectural panel 600 is semi-transparent and includes either an internal or external layer that has a desired color. In some embodiments, architectural panel 600 can be fully transparent and devoid of color. Frame 620 structurally supports architectural panel 600 such that a user can use architectural panel 600 as exterior cladding, interior wall partitions, ceiling panels, roof panels, facade design elements, noise barriers, flooring systems, signage and branding, furniture and cabinetry, rain screens, windows and glazing, curtain walls, skylights, glass partitions, balcony railings and guards, canopies and awnings, transparent roof panels, solar panels, aquarium or pool viewing panels, artistic installations, or as any other similar installation or paneling. In some embodiments, frame 620 can instead be a set of fasteners, clips, brackets, screws, bolts, rivets, adhesive tapes, magnetic fasteners, hooks, latches, gaskets, rubber seals, U-channels, H-channels, Z-clips, panel grips, snap-fit frames, edge clamps, sliding tracks, mounting brackets, track systems, interlocking frames, modular framing systems, hook and loop strips, or any other similar methods of support. Frame 620 can be a free-standing and self-supporting structure, or it may be secured to a wall, ceiling, or flooring.

FIG. 6B illustrates a line drawn side perspective view of architectural panel 600. Pattern 610a is illustrated with an undulating fluid-like pattern. In the illustrated embodiment, pattern 610b is a complementary pattern to pattern 610a such that a viewer can discern fluid-like waves across both major surfaces of architecture panel 600. In another embodiment, patterns 610a and 610b can be registered in such a way that an indentation within pattern 610a is reciprocated as an outward protrusion on pattern 610b and vice versa. As previously discussed, patterns 610a and 610b can exhibit cohesive structural interactions with each other, as indicated by the centerline 622 relative to the interaction line 624. Interaction line 624 can be a thin thermoplastic layer that has been warped, bent, curved, or otherwise altered away from a planar state due to the interactions between patterns 610a and 610b during their simultaneous formation. Interaction line 624 may also indicate the movement of material within a single thermoplastic layer that was shifted from its original position for the same reasons.

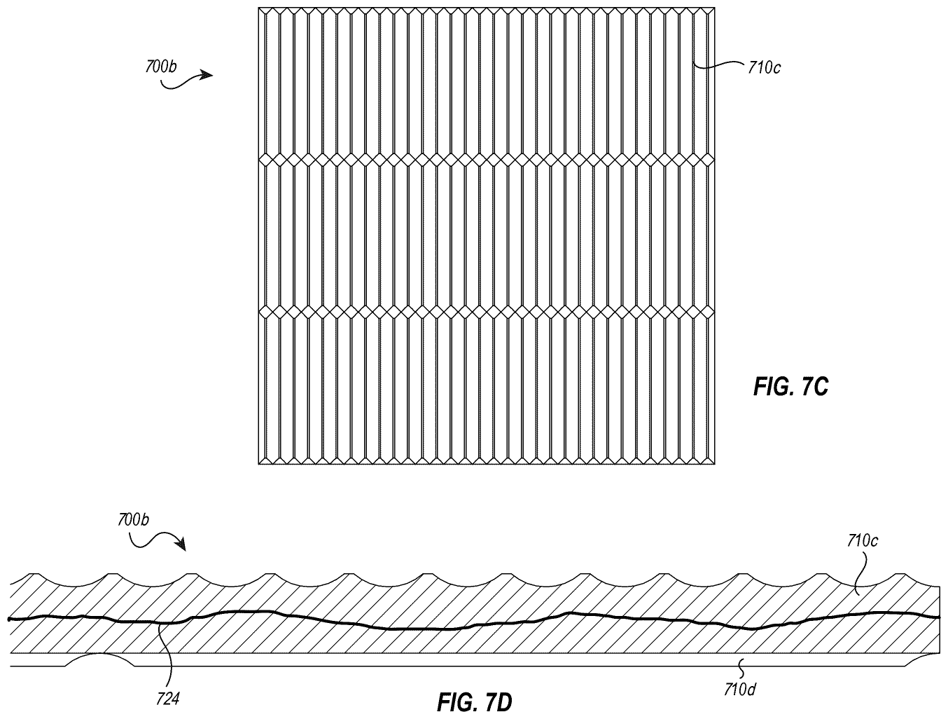

FIGS. 7A through 7D provide various embodiments of architectural panels exhibiting double-sided texture. FIGS. 7A-7B, in particular, show architectural panel 700a having patterns 710a and 710b. As illustrated, patterns 710a and 710b include rolling wave-like surface features (see FIG. 7B). Patterns 710a and 710b are registered 90 degrees relative to each other to provide a cross-hatch pattern as shown in FIG. 7A. This cross-hatch pattern can exhibit an appearance similar to that of a poured molten glass block array. Thus, the present disclosure can provide a manufacturer with the ability to construct glass-like wall styling without using glass and instead using thermoplastic or similar sheets. FIGS. 7C and 7D show architectural panel 700b. Architectural panel 700b has pattern 710c depressed into a first major surface and pattern 710d depressed on its second major surface. Unlike panel 700a, panel 700b is opaque; thus, the see-through effects of registration are not visible through panel 700b itself. In at least one embodiment, panel 700b is at least partially transparent. FIG. 7D still shows, however, that interaction line 724 is still present in cases where the panel is not transparent.

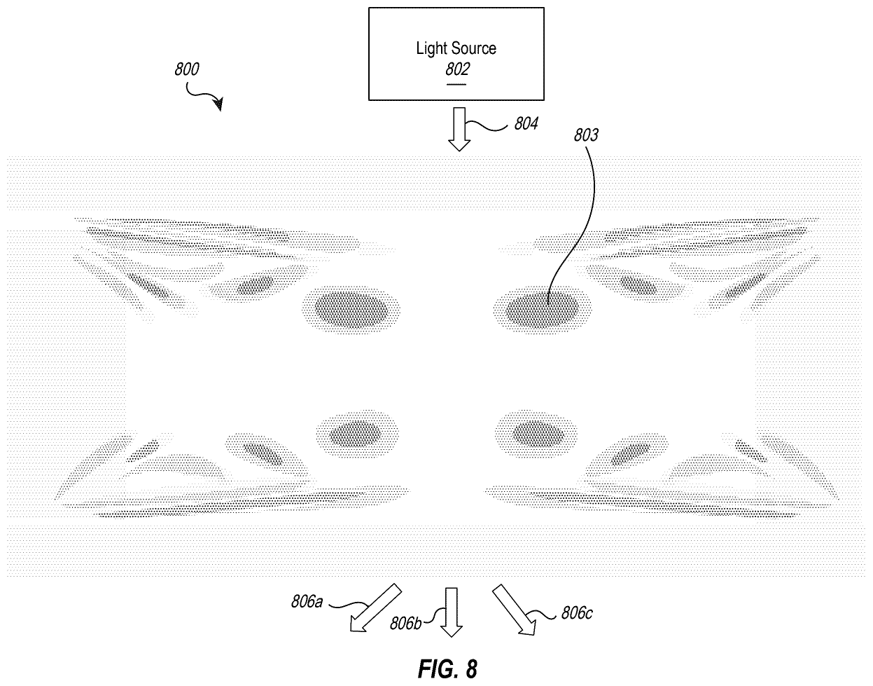

FIG. 8 illustrates an exemplary embodiment of light interaction through and within an architectural panel 800. As shown, light source 802 directs a light wave 804 toward an architectural panel 800, which has double-sided high-relief embossments (not shown) of the present disclosure. As shown, the light wave 804 enters the panel 800 and interacts with the internal surface topology caused by the opposing high-relief embossments, see interaction 803. These interactions 803 may cause the light to refract, scatter, or otherwise shift direction within the panel body. As a result of these interactions 803, the light may exit the panel as a plurality of emergent light waves 806a, 806b, and 806c. In some embodiments, the emergent light waves 806a, 806b, and 806c may represent a separation of color components (e.g., a prismatic effect). Alternatively or additionally, the emergent light waves may indicate a directional shift of the original light wave 804. Thus, the emergent light waves can be a lighting effect or a visual effect caused by light traveling through the panel 800. Non-limiting examples of lighting or visual effects can include a prismatic effect, a refraction effect, a diffraction effect, a diffusion effect, a scattering effect, a hazing effect, a gradient or banding effect, Moiré effect, a shimmer, a glare highlight, a shadowing effect, a mottling effect, an opacity variation, a brightening or dimming effect, a color shift, a tinting effect, a reflection highlight, or combinations thereof. The internal interaction 803 or light effects may be defined by the structural interactions between the first and second high-relief embossments, and may contribute to visual phenomena such as diffusion, refraction, or color dispersion observable from one or both sides of the panel.

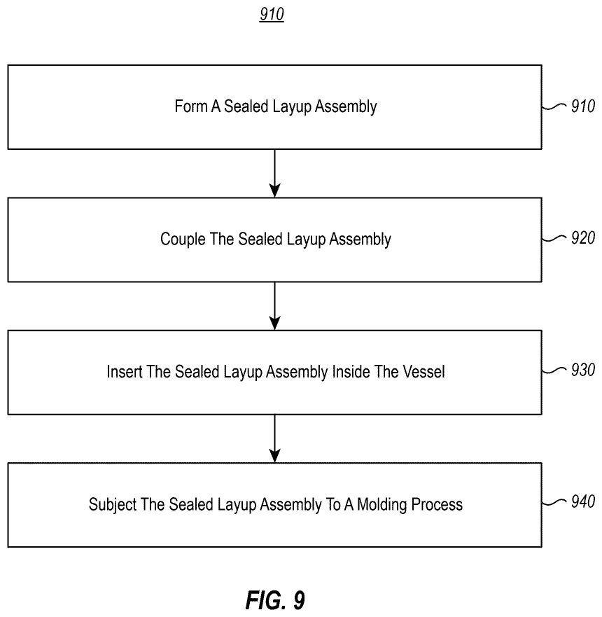

FIG. 9 illustrates method 900 for manufacturing an architectural panel with high-relief embossments on a first major surface and a second major surface. The acts of method 900 may utilize the above-described process, such as those of FIGS. 1A-1D. Method 900 can include act 910 of forming a sealed layup assembly. Act 910 can include forming a sealed layup assembly comprising a first mold, a second mold, one or more release films, a thermoplastic sheet, and a flexible vacuum container. For example, as illustrated in FIGS. 1A and 4, the sealed layup assembly can be formed by stacking a first mold (100a, 402a), one or more release films (120), and a thermoplastic sheet (110, 406a-c), followed by additional release films and a second mold (100b, 402b). These layers can then be enclosed within a flexible vacuum container (130, 520) to create a sealed layup assembly (140, 500). Valves (131, 510) can be incorporated into the vacuum container to permit evacuation of air and facilitate monitoring of pressure during the molding process.

Method 900 can further comprise act 920 of coupling the sealed layup assembly. Act 920 can include coupling the sealed layup assembly to a vessel through one or more tubes configured to allow for a transfer of air between the sealed layup assembly and the vessel. For example, as shown in FIGS. 1B and 5, the sealed layup assembly (140, 500) can be coupled to a vessel (150) by one or more tubes extending through valves (131, 510). These tubes allow air transfer between the sealed layup assembly and the vessel to establish and maintain a controlled vacuum environment.

Method 900 may still further comprise act 930 of inserting the sealed layup assembly inside the vessel. Act 930 can include inserting and sealing the sealed layup assembly inside the vessel, wherein the vessel has a temperature and a pressure. For example, as depicted in FIGS. 1C and 1D, the sealed layup assembly (140) can be positioned within a heated pressure vessel (150). The vessel may be an autoclave, lamination press, or other suitable pressurization system, which is then sealed to apply uniform temperature and pressure across the assembly.

Method 900 can also comprise act 940 of subjecting the sealed layup assembly to a molding process. Act 940 can include subjecting the sealed layup assembly to a molding process at a predetermined temperature, a predetermined pressure, and a predetermined duration, wherein the predetermined temperature causes an internal temperature of the thermoplastic sheet to meet or exceed 210 degrees Fahrenheit. For example, as described in the above processes and shown in FIG. 1C, the sealed layup assembly is subjected to controlled heat and pressure cycles. The vessel temperature is increased such that the internal temperature of the thermoplastic sheet meets or exceeds 210° F. or an alternative desired temperature. At the same time, the applied pressure ranges from about 10 to 200 PSI, or between other ranges of pressures. These conditions are maintained for a predetermined duration (e.g., 80-450 minutes) to permit the thermoplastic sheet to conform fully to both molds simultaneously, producing high-relief embossments (212a, 212b; 610a, 610b) on both major surfaces of the resulting panel. A controlled ramp-down of temperature and pressure preserves embossment fidelity and prevents slippage of the stacked layers.

In addition, it will be understood that features and method steps described in connection with one embodiment may be combined with features of another embodiment, even where such combinations are not expressly set forth herein. Substitutions of materials, manufacturing steps, or forming equipment that achieve substantially the same function or result are likewise contemplated. Furthermore, the invention encompasses variations that make use of later-developed materials, forming techniques, or processing conditions that were not available at the time of filing but that nevertheless operate to achieve the double-sided, high-relief embossments disclosed herein.

For example, while the foregoing description illustrates the use of a flexible vacuum container in combination with an autoclave, alternative forming systems may be employed, such as hydraulic presses, pneumatic presses, screw presses, roller-based lamination systems, or other heat-and-pressure devices capable of producing simultaneous embossments. Similarly, the molds may be constructed from a variety of materials, such as metals, elastomers, ceramics, composites, or hybrid structures, and may include surface treatments such as coatings, texturing, or polishing to achieve distinct finishes. In other embodiments, the thermoplastic sheet may be substituted or supplemented with multiple layers of differing transparency, opacity, or color, such as PETG, PC, PMMA, TPU, or combinations thereof, to achieve desired structural or visual effects. The heating may be accomplished through conduction, convection, radiant heat, or induction, and the pressure may be applied through direct compression, vacuum-assisted lamination, or fluid pressure systems. These variations, such as the non-limiting list above, are contemplated so long as they achieve the formation of double-sided, high-relief embossments as disclosed.

The present invention may be embodied in other specific forms and embodiments without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. An architectural panel, comprising:
a first major surface having a first high-relief embossment depressed therein; and
a second major surface opposite the first major surface, the second major surface having a second high-relief embossment depressed therein,
wherein:
the first high-relief embossment and the second high-relief embossment comprise a surface topology defined by one or more depressed regions;
the one or more depressed regions of the first high-relief embossment exhibit cohesive structural interactions with the one or more depressed regions of the second high-relief embossment through a thickness of the architectural panel.

2. The architectural panel of claim 1, wherein the first high-relief embossment has a depth of at least 0.125 inches.

3. The architectural panel of claim 1, wherein the first high-relief embossment has a depth of at least 0.15 inches or at least 0.25 inches, and wherein a height difference between at least one of the one or more depressed regions and an unmolded remainder of the first major surface defines the depth.

4. The architectural panel of claim 2, wherein the second high-relief embossment has a depth of at least 0.125 inches.

5. The architectural panel of claim 2, wherein the second high-relief embossment has a depth of at least 0.25 inches.

6. The architectural panel of claim 1, wherein the architectural panel is a thermoplastic sheet formed from a material from a group consisting of polyvinyl chloride (PVC), polyethylene terephthalate with glycol-modification (PETG), thermoplastic polyurethane (TPU), polycarbonate (PC), or polymethyl methacrylate (PMMA).

7. The architectural panel of claim 1, wherein the architectural panel is a laminated panel comprising two or more layers.

8. The architectural panel of claim 6, wherein the architectural panel comprises at least three layers of thermoplastic sheets, and at least one of the three thermoplastic sheets is of a chosen color.

9. The architectural panel of claim 1, wherein the architectural panel is semi-transparent or translucent.

10. The architectural panel of claim 1, wherein:
the first high-relief embossment comprises an aperiodic pattern; and
the second high-relief embossment comprises a periodic pattern or an aperiodic pattern.

11. The architectural panel of claim 1, wherein the architectural panel has a thickness of about 0.20 inches.

12. The architectural panel of claim 1, wherein one or more depressed regions consist of material from the architectural panel, formed through a movement of the material, and not from additive manufacturing.

13. The architectural panel of claim 1, wherein an area of the first major surface not defined by the one or more depressed regions defines a level outer surface of the first major surface.

14. An architectural panel, comprising:
a first major surface having a first high-relief embossment depressed therein; and
a second major surface opposite the first major surface, the second major surface having a second high-relief embossment depressed therein, wherein:
the first high-relief embossment and the second high-relief embossment were formed simultaneously during a heating process,
the first high-relief embossment and the second high-relief embossment exhibit substantially similar fidelity, depth, and surface finish, and
the first high-relief embossment and the second high-relief embossment each have a depth of at least 0.125 inches.

15. The architectural panel of claim 14, wherein:
the first high-relief embossment comprises a surface topology defined by one or more protruding regions and one or more depressed regions; and
the first high-relief embossment forms a three-dimensional texture imparted into the first major surface of the panel.

16. The architectural panel of claim 15, wherein:
at least one depressed region of the one or more depressed regions comprises a continuous depth along a length or for a distance across the first major surface, and
at least one recessed region forms a linear or non-linear channel.

17. The architectural panel of claim 14, wherein an orientation of the second high-relief embossment is registered at an angle of about 90 degrees relative to the orientation of the first high-relief embossment.

18. An architectural panel, comprising:
a first major surface having a first high-relief embossment depressed therein; and
a second major surface opposite the first major surface, the second major surface having a second high-relief embossment depressed therein,
wherein:
the first high-relief embossment and second high-relief embossment comprise a surface topology defined by one or more depressed regions,
the one or more depressed regions of the first high-relief embossment exhibit cohesive structural interactions with the one or more depressed regions of the second high-relief embossment through a thickness of the architectural panel,
the first high-relief embossment and the second high-relief embossment cause a light that passes through the architectural panel to exhibit a visual effect, and
the one or more depressed regions of the first high-relief embossment and the second high-relief embossment each have a depth of at least 0.125 inches.

19. The architectural panel of claim 18, wherein:
the visual effect includes a prismatic effect, and
the light that passes through the architectural panel is refracted and dispersed by the surface topology of the first high-relief embossment and the second high-relief embossment to produce a spectrum of colors visible to an observer positioned on either side of the panel.

20. A method for manufacturing an architectural panel of claim 1, comprising:
forming a sealed layup assembly comprising a first mold, a second mold, one or more release films, a thermoplastic sheet, and a flexible vacuum container:
coupling the sealed layup assembly to a vessel through one or more tubes configured to allow for a transfer of air between the sealed layup assembly and the vessel;
inserting and sealing the sealed layup assembly inside the vessel, wherein the vessel has a temperature and a pressure; and
subjecting the sealed layup assembly to a molding process at a predetermined temperature, a predetermined pressure, and a predetermined duration, wherein the predetermined temperature causes an internal temperature of the thermoplastic sheet to meet or exceed 210 degrees Fahrenheit,
wherein the first high-relief embossment is formed on the first major surface and a second high-relief embossment is formed on the second major surface simultaneously.
